(19) United States
(12) Patent Application Publication
(10) Pub. No.: US 2021/0358230 A1
(43) Pub. Date: Nov. 18, 2021

(54) TIMING DEVICE

(71) Applicant: Interprobe GmbH, Grünwald (DE)

(72) Inventors: Robert Ramholz, Munich (DE); Wolfgang Alexander Paes, Gifhorn (DE)

(21) Appl. No.: 16/630,695

(22) PCT Filed: Jun. 26, 2018
(86) PCT No.: PCT/EP2018/067062

§ 371 Date: Jan. 13, 2021

(30) Foreign Application Priority Data
Jul. 14, 2017 (DE) 10 2017 212 107.6

(51) Int. Cl. G07C 1/24; G04G 21/00; G04F 13/02

(52) U.S. Cl. CPC G07C 1/24; G04F 13/02; G04G 21/00

(57) ABSTRACT

The present invention relates to a device for time measurement of a sporting movement of a person, wherein the device comprises a housing and a proximity sensor. According to the invention, the proximity sensor is formed to emit a signal for detection of the movement and to receive a reflection of the signal at the person for time measurement. To this end, the proximity sensor is arranged in the housing in such a manner that the movement in a longitudinal direction and at least in another direction can be detected.

The present invention relates to a device for time measurement of a sporting movement of a person, comprising a housing and a sensor.

### PRIOR ART

A sporting movement of a person such as, for example, running of a human or an animal is tracked with the aid of devices from the prior art. In this case, there are devices which document the movements of the person with the aid of light barriers.

Light barriers must have a special structure for this purpose. This means that either mobile devices have to be aligned in a complex manner to ensure the function of the light barriers or stationary devices are used. Mirrors often have to be used which are to be positioned in such a manner that a light emitted by a sensor is reflected onto a sensor which receives the light. The alignment of the mirror and of the sensor is complex in particular if large distances between the sensor and mirror are used so that, for example, the person or animal can easily pass through the light barrier.

As a result of the complex installation, such devices are often used in a stationary manner, with alignment and adjustment only essentially having to be carried out once so that the device can be used.

However, the problem arises here that the device cannot be used in a mobile fashion and furthermore does not allow any variation of the position of the light barrier.

### SUMMARY OF THE INVENTION

Proceeding from the prior art, the object therefore arises of providing a device which enables variable and mobile possibility of use.

According to the above object, the present invention provides a device for time measurement of a sporting movement of a person, wherein the device comprises a housing and a sensor.

According to one embodiment of the invention, the sensor is, for example, a proximity sensor and serves to emit a signal for detection of movement and for receiving a reflection of the signal at the person for time measurement. For this purpose, the proximity sensor is arranged in the housing in such a manner that the movement in a longitudinal direction and at least in another direction can be detected.

The present embodiment of the invention furthermore provides a method for time measurement of a sporting movement of a person using the device, the method comprises an emission of a signal for detection of movement and a receiving of a reflection of the signal at the person for time measurement, a detection of the movement transverse to a longitudinal direction, and a detection of the movement in at least one other direction than the longitudinal direction.

The present invention makes it possible to detect a sporting movement in a variable and mobile manner. In particular, the present invention enables a simple structure and can therefore be used in a mobile manner, for example, in sporting venues, in buildings, outdoors, at events, at a competition, for entertainment, etc. In particular, the device according to the present invention can be set up and used immediately without a complex alignment of the elements such as, for example, the sensors.

In particular, the device according to the present invention can, in one preferred embodiment, independently check, i.e. scan, the surroundings of the device, detect stationary objects and track moving persons.

### BRIEF DESCRIPTION OF THE FIGURES

FIG. 1 is a schematic representation of a first embodiment of the present invention.

FIG. 2 is a schematic representation of a second embodiment of the present invention.

FIG. 3 is a schematic flow chart of a method according to the present invention.

FIG. 4 is a schematic representation of a possible form of use of the present invention.

FIG. 5 is a representation of the device according to the present invention according to a further embodiment.

FIGS. 6A and 6B are representations of the device from FIG. 5 with an open housing.

FIG. 7 is a further representation of a further embodiment of the present invention.

### DETAILED DESCRIPTION OF THE EMBODIMENTS

Preferred embodiments of the present invention are explained below on the basis of the enclosed figures. The embodiments are only by way of example and can in each case be combined in a suitable manner, with the present invention only being restricted by the subject matter of the claims.

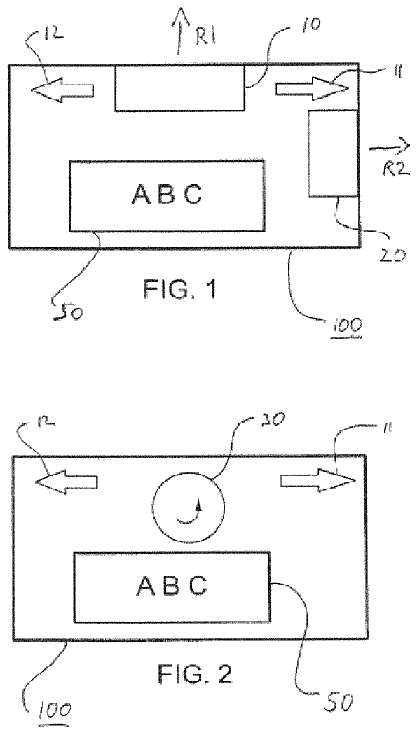

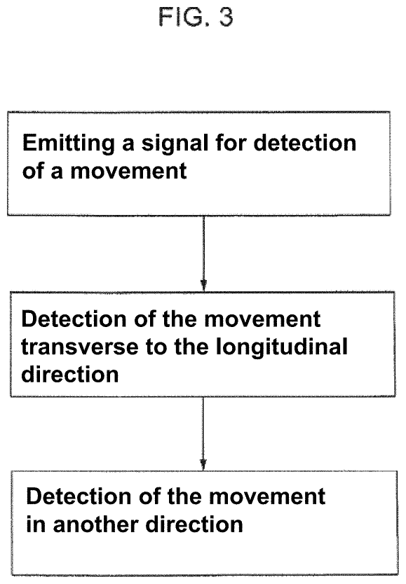

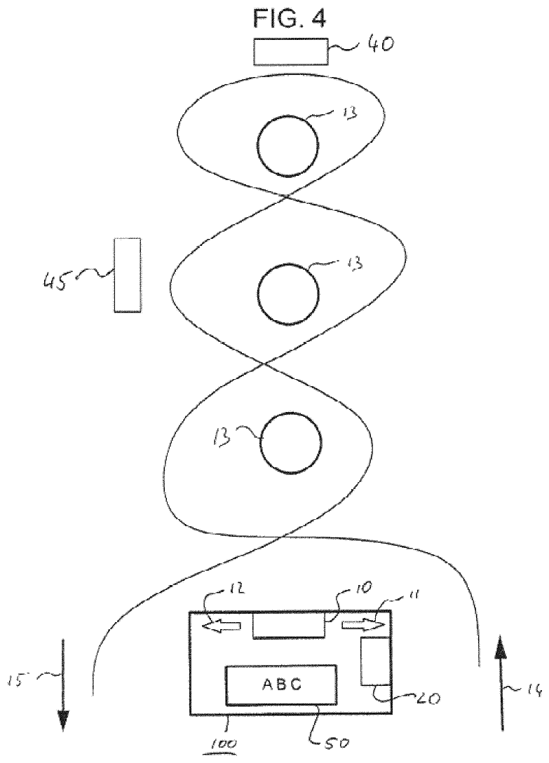

FIG. 1 shows a first embodiment of the present invention on the basis of device 100. Device 100 comprises, in the represented embodiment, at least two proximity sensors 10, 20, an input element 50 and signal transmitters 11, 12.

Proximity sensors 10, 20 are also referred to as proximity switches or proximity initiators, and these react to the proximity of a person without direct contact. Proximity sensors 10, 20 emit a signal for detection of the movement of a person. In this case, the signal emitted by proximity sensor 10, 20 is reflected at the person and received and evaluated by the proximity sensor. The mode of operation of proximity sensors in general is known from the prior art and is therefore not explained further here.

For evaluation, the device can have a storage means, a processor and a communication means. The storage means can locally store the signals output by the sensor. With the aid of software, the processor can evaluate the stored signal or the stored signal can be transmitted with the aid of the communication means to an external unit (not represented) for evaluation. In particular, the storage means can store a computer program for execution by the processor.

Such a proximity sensor not only enables detection of the position upon a light barrier being broken through, but rather enables the chronological and position-related movement of the person to be tracked. For example, a complex course or a training unit can thus be tracked precisely.

In particular, proximity sensor 10 is arranged in such a manner that the movement in a longitudinal direction R1 can be detected. In this embodiment, proximity sensor 10 is arranged in such a manner that longitudinal direction R1 extends along the longitudinal axis of a course, as represented in FIG. 4.

Proximity sensor 20 is arranged in such a manner that the movement in another direction R2 can be detected. In this embodiment, other direction R2 is formed perpendicular to longitudinal direction R1. In a further embodiment, proximity sensor 20 can be formed as a different sensor such as, for example, a light barrier. It is furthermore conceivable that proximity sensor 20 is replaced by a switch which is triggered by the person.

Signal transmitters 11, 12, also referred to as a display element, are formed in this embodiment as arrows which are anti-parallel to one another in direction R1. These serve to indicate the running direction and can be formed as optical or acoustic elements.

Input element 50 serves to select, for example, a program, for the input of information relating to the person, information relating to the application, etc. Input element 50 can be formed, for example, as a touchscreen or a keyboard with a corresponding display.

FIG. 2 shows a further embodiment of the present invention, wherein device 100 has in each case display elements 11, 12 and input element 50. In contrast to the first embodiment, however, this second embodiment has a single proximity sensor 30. Said single proximity sensor 30 can be formed, for example, as a rotating proximity sensor. Said proximity sensor 30 can thus track the movement of a person around device 100, for example, by 360°. Said proximity sensor 30 accordingly offers an all-round view and makes it possible to track a complex movement of the person. For example, a course described in FIG. 4 can be tracked not only in one direction, but rather in several directions relative to device 100.

In one embodiment of the present invention, it is provided that the device further has a printer unit or a display unit for outputting the time measurement. Device 100 can comprise, for example, a printer element which is integrated, for example, into the device, and can be connected with a cable or wirelessly. For example, running results can be output directly with the printer element.

In a further embodiment of the present invention, it is provided that the device further has a communication interface for connection to a data network. For example, the communication element can connect device 100 to a server on which, for example, running results are stored in order to compare these with one another. This enables, for example, a competition to be run between participants who are located, for example, at different locations or use the device at different times. For example, the device can be taken from one location to the next in order to record the running results of a plurality of persons.

In one embodiment of the present invention, it is provided that the signal for detection of the movement is an optical, acoustic or electromagnetic signal. This means that proximity sensors 10, 20, 30 are formed as optical, acoustic or electromagnetic sensors.

FIG. 4 shows an exemplary application of device 100. For example, elements 13 which define a course can be used. A person, for example a runner, begins on the right-hand side of device 100 and triggers proximity sensor 20 by virtue of the fact that he or she runs past device 100 in the direction of arrow 14.

The person accordingly passes device 100 in such a manner that proximity sensor 10 detects the movement and also records data in terms of time and position. The person runs further, for example, in a slalom around elements 13. For example, pylons or something similar can be used as elements 13. Each time when the person passes device 100 in the longitudinal direction, proximity sensor 10 detects the movement of the persons and stores the corresponding data, for example, in terms of time and position.

Once the person has successfully crossed the slalom or the course, he or she once again runs past the side of device 100, for example, in the direction of arrow 15 and thus triggers the end of the time measurement. Either proximity sensor 20 or a further proximity sensor (not represented) or a different sensor or a manual input can be used for this purpose.

Device 100 can furthermore have additional proximity sensors 40, 45. These can be connected, for example, wirelessly or by cables to device 100. It should be pointed out that proximity sensors 10, 20 can also be connected wirelessly so that these can be removed from device 100 and can be placed on the course or in the surroundings of device 100.

Additional proximity sensors 40, 45 can be placed in the surroundings of device 100 in such a manner that the course can be formed, for example, to be longer in order to cover a longer distance or in such a manner that a complicated course can be set up and the person tracked. This means that additional proximity sensors 40, 45 can extend the range of the device.

In FIG. 4, only the positioning for detection in the longitudinal direction or in the direction perpendicular thereto is represented, but proximity sensors 40, 45 can track the movement of the person in any desired direction. A plurality of additional proximity sensors can also be used. These can be connected and set up, for example, in what is known as a mesh network.

The data output by the sensors are subsequently evaluated either in device 100 or, for example, on a server (not represented) and, for example, a running result is output.

If a device according to the second embodiment, which uses a proximity sensor 30 which is rotatable all the way round, is used in the case of the application according to FIG. 4, a complex course can be constructed by means of a plurality of elements 13 in several directions. For this purpose, device 100 can be placed, for example, in the centre of the course in order to detect the running results.

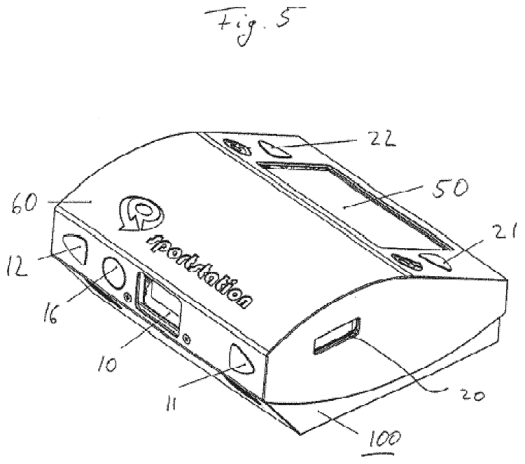

FIG. 5 shows a further embodiment of the present invention, wherein device 100 is provided with a housing 60. Housing 60 accommodates the elements of device 100.

The embodiment furthermore has a camera for single image or video recordings of the movement. The person can thus be tracked during the time, for example, in the course represented in FIG. 4 with the aid of a single image or a video recording. The data can be combined with the running results and can serve the purpose, for example, of complex running analysis.

The embodiment represented in FIG. 5 furthermore has display elements 21, 22 which can display the running direction, for example, to a user of device 100.

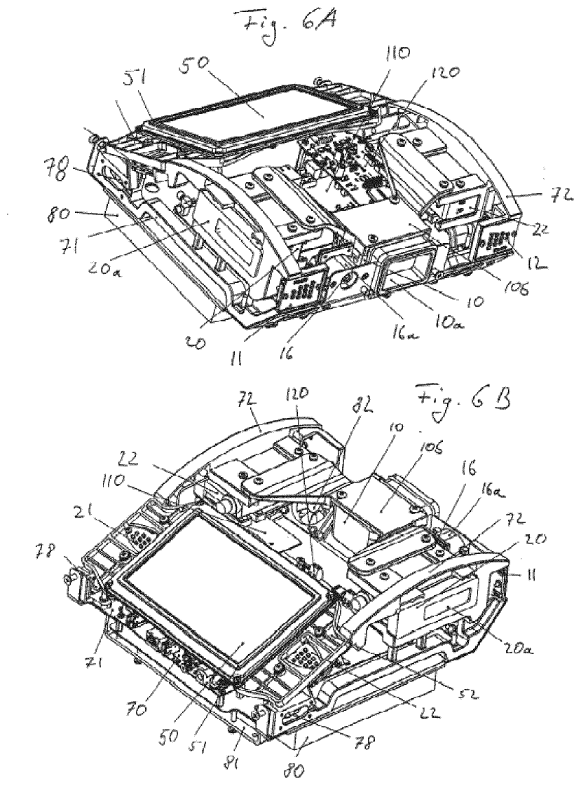

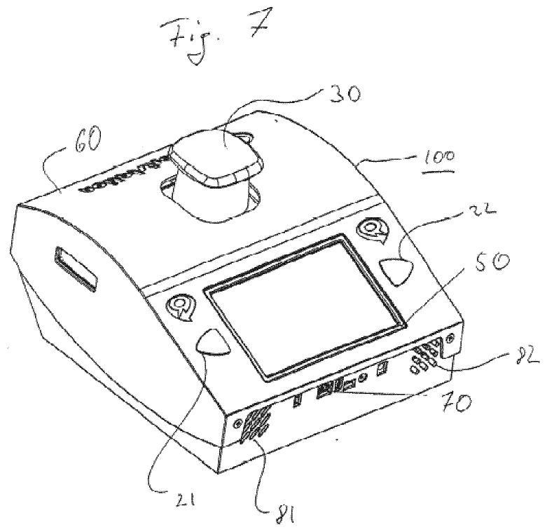

FIGS. 6A and 6B show the embodiment represented in FIG. 5 of device 100 with an open housing. The represented embodiment comprises sensor-holding elements 10a, 20a, a sensor cover 10b, a camera-holding element 16a, a sensor element 22, a cover 51, a holding element 52, carrying elements 71, 72, a loudspeaker 78, a battery element 80, a battery-holding element 81, a fan 82, processor 110 and storage element 120.

FIG. 7 shows a further embodiment of the present invention, wherein the device comprises proximity sensor 30 which detects the movement of the person, for example, around 360° of device 100. Proximity sensor 30 is formed, for example, in this embodiment as a telescopic element which can be lowered into housing 60. Proximity sensor 30 can thus be accommodated in housing 60 in order to transport device 100, and proximity sensor 30 can extend in a telescopic manner out of housing 60 when using device 100 for detection of movement.

Moreover, in this embodiment, various interfaces 70 are represented with which device 100 can be connected to other devices in order, for example, to exchange data. Openings 81, 82 are further provided which serve to cool the electronic elements in housing 60.

According to a further embodiment, the device for time measurement of the sporting movement of the person is formed such that the sensor is formed as an optical camera.

The optical camera can be, for example, an optical camera for recording moving images which are stored in a storage unit. The camera can preferably be provided with an image range to be recorded of 180° or 360° around the device.

The camera can further have an optical element and/or an electronic element in order to generate a signal comprising the recorded images. A software module for controlling the camera can be provided. For example, a specific region in the field of vision of the camera can be selected which is to be recorded by the camera.

The signal received by the camera can be immediately processed or can firstly be stored temporarily on the storage unit in order to be processed later. A software module can be provided to process the signal.

The software module for processing the signal can track, for example, a movement of the person in the field of vision of the camera over a certain period of time and derive specific parameters such as speed, direction and the like from the signal or the recorded images.

The embodiment of the present invention, comprising the camera and the software module, has the advantage of being a low-cost alternative to the embodiments described above, and can be used in particular in the case of lower requirements in terms of precision.

In one further modification of the above embodiment, an optical camera with a very high number of image recordings per unit of time can be used, such as, for example, a high-speed camera. This makes it possible to also satisfy high requirements in terms of precision when using an optical camera according to the present embodiment.

The present invention further comprises a computer program comprising program code, wherein the program code, if it is executed on a processor, instructs the processor to execute a method according to the invention.

The present invention further comprises a computer program product which stores a comprehensive program code, wherein the program code, if it is executed on a processor, instructs the processor to execute a method according to the invention.

1. A device for time measurement of a sporting movement of a person, the device comprising:
a housing; and
a proximity sensor configured to emit a signal for detection of the sporting movement and to receive a reflection of the signal at the person for time measurement;
the proximity sensor arranged in the housing to detect the movement in a longitudinal direction and at least in another direction.

2. The device according to claim 1, wherein the proximity sensor comprises a first sensor element configured to detect the movement in the longitudinal direction and a second sensor element configured to detect the movement in the other direction.

3. The device according to claim 1, wherein the proximity sensor is configured to rotate to detect the movement in the longitudinal direction and in the other direction.

4. The device according to claim 1, wherein the signal for detection of the movement is an optical, acoustic or electromagnetic signal.

5. The device according to claim 1, further comprising a camera for single image or video recording of the movement.

6. The device according to claim 1, further comprising at least one signal transmitter configured to display instructions to the person.

7. The device according to claim 1, further comprising a communication interface configured to be connected to a data network.

8. The device according to claim 1, further comprising a printer unit or a display unit configured to output the time measurement.

9. A method for time measurement of a sporting movement of a person, using a device comprising a housing and a proximity sensor, the method comprising acts of:
emitting a signal for detection of the sporting movement and receiving a reflection of the signal at the person for time measurement;
detecting the sporting movement transverse to a longitudinal direction; and
detecting the sporting movement in at least one other direction than the longitudinal direction.

10. A computer program comprising program code, wherein the program code, when executed on a processor, instructs the processor to execute a method according to claim 9.

11. A computer program product storing a program code, wherein the program code, when executed on a processor, instructs the processor to execute a method according to claim 9.
